(19) United States
(12) Patent Application Publication
(10) Pub. No.: US 2017/0347015 A1
(43) Pub. Date: Nov. 30, 2017

(54) Method, device, and terminal for adjusting focal length

(71) Applicant: ZTE Corporation, Shenzhen (CN)

(72) Inventor: Mingdong PAN, Shenzhen (CN)

(73) Assignee: ZTE Corporation, Shenzhen (CN)

(21) Appl. No.: 15/518,038

(22) PCT Filed: Jan. 4, 2015
(86) PCT No.: PCT/CN2015/070061

§ 371 Date: Apr. 10, 2017

(30) Foreign Application Priority Data
Oct. 10, 2014 (CN) 201410530802.3

(51) Int. Cl. H04N 5/232; G06K 9/62; G06K 9/00; H04N 7/14; H04N 5/247

(52) U.S. Cl. CPC H04N 5/23212; H04N 5/23219; G06K 9/6202; G06K 9/00255; H04M 2250/52; H04N 5/247; H04N 7/141

(57) ABSTRACT

A method, device and terminal for adjusting focal length are provided. The method includes: after a camera of a terminal is detected to have been started, acquiring a first distance between the subject being captured by the camera and the camera; acquiring a first focal length corresponding to the first distance according to the first distance; and automatically adjusting the focal length of the camera to be the first focal length.

### TECHNICAL FIELD

The present disclosure relates to the technical field of communication applications, and more particularly to a method, device and terminal for adjusting the focal length of a camera.

### BACKGROUND

At present, smart phone is becoming a very common communication tool, and almost each smart phone has the camera function, which is becoming more and more powerful, and the photo is clearer. The Smart phone gives a very large convenience to our lives. We can take pictures anywhere anytime when taking smart phones, without the need of taking a special camera. In addition to taking pictures, we can also have video calls, etc., with the help of a smart phone platform. With the increasing internet speed and the upgrading of the camera module hardware, video calls based on the mobile phones are applied more frequently.

In the process of taking a photo or having a video call, the focal length needs to be manually adjusted, which is sometimes very inconvenient. For example, in the process of taking a selfie, a rear camera is usually used. At this time, we cannot preview the photo on the screen, so we can only take photos by effort. The shooting effect is often not good enough due to the inappropriate adjustment of the focal length.

During a video call, a front camera is usually used. We usually get close to the phone when we talk, and depart from the phone when the talk is finished. If the focal length is not adjusted when we get close to the phone to talk, it is difficult for the called party to see us clearly because we get too close to the phone, thus the user experience is decreased.

### SUMMARY

In the embodiments of the present disclosure, a method, a device and a terminal for adjusting the focal length are provided, to intend to solve the problem that a camera cannot automatically adjust the focal length according to the distance between a user and the camera when the user takes a selfie or makes a video call.

In one aspect of the disclosure, an embodiment of the present disclosure provides a method for adjusting focal length, and the method includes: after the start of the camera of the terminal is, a first distance between the subject being captured by the camera and the camera is acquired; a first focal length corresponding to the first distance is acquired according to the first distance; and the focal length of the camera is automatically adjusted to be the first focal length.

In an exemplary embodiment, the step of acquiring a first distance between the subject being captured by the camera and the camera after the start of the camera of the terminal is detected includes: the first distance between the subject being captured by the camera and the camera is acquired by an infrared sensor, a Hall component, or an ultrasonic sensor in the terminal.

In an exemplary embodiment, the step of acquiring a first focal length corresponding to the first distance according to the first distance includes: a preset first relation table stored in the terminal is acquired, and the preset first relation table includes a distance value and a scale factor stored according to a corresponding relationship; a first scale factor corresponding to the first distance is acquired according to the corresponding relationship in the preset first relation table; and a first focal length corresponding to the first distance is determined according to the first scale factor.

In an exemplary embodiment, the step of determining a first focal length corresponding to the first distance according to the first scale factor comprises: a first focal length corresponding to the first distance is determined by the formula X=K*D, where K presents a scale factor, D presents a focal length of the front camera, and X presents a first focal length.

In an exemplary embodiment, the subject is a human face; and the step of acquiring a distance between the subject being captured by the camera and the camera after the start of the camera of the terminal is detected includes: the size of the face recognition frame on the terminal screen is acquired by a face recognition module of the terminal; a preset second relation table stored in the terminal is acquired, and the preset second relation table includes: the size of the terminal screen; and the size of the face recognition frame with the size of the terminal screen is compared to acquire a first relative size for identifying a first distance between the human face and the camera.

In an exemplary embodiment, the preset second relation table further includes: a relative size and a scale factor stored according to a corresponding relationship.

In an exemplary embodiment, the step of acquiring a first focal length corresponding to the first distance according to the first distance includes: a first scale factor corresponding to the first relative size is acquired according to the corresponding relationship in the preset second relation table; and a first focal length corresponding to the first relative size is determined according to the first scale factor.

In an exemplary embodiment, after the step of automatically adjusting the focal length of the camera to be the first focal length, the method further includes: when the first distance is changed, It is judged whether the scale factor is changed according to the scale range in the preset relation table stored in the terminal, and the preset relation table includes the following parameters stored according to a corresponding relationship: a distance value, the scale range where the distance value is located, and the scale factor; and the focal length of the camera is re-adjusted according to the current scale factor when the scale factor is changed.

In another aspect of the disclosure, an embodiment also provides a device for adjusting focal length, and the device includes: a first acquiring module configured to, after the start of the camera of the terminal is detected, acquire a first distance between the subject being captured by the camera and the camera; a second acquiring module configured to acquire a first focal length corresponding to the first distance according to the first distance; and a first adjusting module configured to automatically adjust the focal length of the camera to be the first focal length.

In an exemplary embodiment, the first acquiring module includes: a first acquiring unit configured to acquire a first distance between the subject being captured by the camera and the camera by an infrared sensor, a Hall component, or an ultrasonic sensor in the terminal.

In an exemplary embodiment, the second acquiring module includes: a second acquiring unit configured to acquire a preset first relation table stored in the terminal, and the preset first relation table includes a distance value and a scale factor stored according to a corresponding relationship; a third acquiring unit configured to acquire a first scale factor corresponding to the first distance according to the corresponding relationship in the preset first relation table; and a first determining unit configured to determine a first focal length corresponding to the first distance according to the first scale factor.

In an exemplary embodiment, the subject captured by the camera is a human face; and the first acquiring module includes: a fourth acquiring unit configured to acquire the size of the face recognition frame on the terminal screen by a face recognition module of the terminal; a fifth acquiring unit configured to acquire a preset second relation table stored in the terminal, and the preset second relation table includes the size of the terminal screen; and a comparing module configured to compare the size of the face recognition frame with the size of the terminal screen to acquire a first relative size for identifying a first distance between the human face and the camera.

In an exemplary embodiment, the second acquiring module includes: a sixth acquiring unit configured to acquire a first scale factor corresponding to the first relative size according to the corresponding relationship in the preset second relation table; and a second determining unit configured to determine a first focal length corresponding to the first relative size according to the first scale factor.

In the above device for adjusting focal length, the device further includes: a judging module configured to, after automatically adjusting the focal length of the camera to be the first focal length, and when the first distance is changed, judge whether the scale factor is changed according to the scale range in the preset relation table stored in the terminal, and the preset relation table includes a distance value, the scale range where the distance value is located, and the scale factor, and them stored according to a corresponding relationship; and a second adjusting module configured to readjust the focal length of the camera according to the current scale factor when the scale factor is changed.

The embodiment of the present disclosure also provides a terminal, and terminal includes the device for adjusting focal length as described above.

The embodiments of the present disclosure have the following advantageous effects.

In the embodiments of the present disclosure, in the provided method for adjusting focal length, after a camera of a terminal is detected to have been started, a first distance between the subject being captured by the camera and the camera is acquired, and a first focal length corresponding to the first distance is acquired according to the first distance, so as to the focal length of the camera is automatically adjusted to be the first focal length. In the embodiments of the present disclosure, the focal length can be dynamically adjusted according to the distance between a person and a mobile phone, so that the terminal screen always displays an image in an appropriate ratio, thereby greatly increasing the user experience.

### BRIEF DESCRIPTION OF THE DRAWINGS

FIG. 1 is a flowchart according to an embodiment of the present disclosure.

FIG. 2 is a flowchart according to the embodiment one of the present disclosure.

FIG. 3 is a flowchart according to the embodiment two of the present disclosure.

FIG. 4 is a structure diagram according to an embodiment of the present disclosure.

### DETAILED DESCRIPTION OF THE EMBODIMENTS

It will be described in detail below with reference to specific embodiments and the accompanying drawings so that the technical problems, technical solutions and advantages to be solved by the present disclosure will become more apparent.

The embodiments of the present disclosure provides a method, device, and terminal for adjusting focal length, for solving the problem that a camera cannot automatically adjust the focal length according to the distance between a user and the camera when the user takes a selfie or makes a video call.

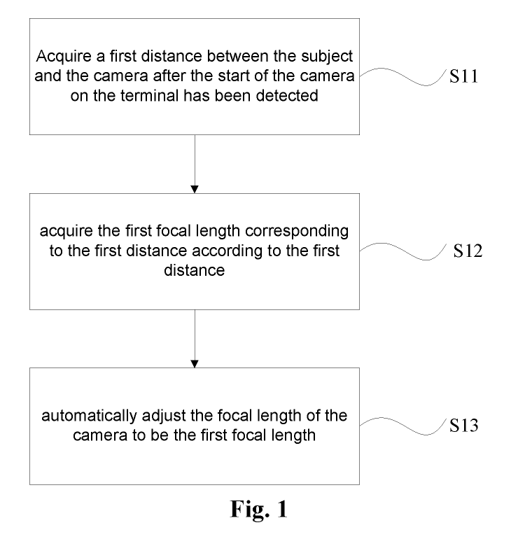

The method for adjusting focal length according to the embodiment of the present disclosure, as shown in FIG. 1, the method includes the steps S11 to S13.

At Step S11: After a camera of a terminal is detected to have been started, a first distance between the subject being captured by the camera and the camera is acquired.

In a specific embodiment of the present disclosure, a first distance between the subject being captured by the camera and the camera may be acquired by an infrared sensor, a Hall component, or an ultrasonic sensor. Of course, any device that can acquire the above first distance can be applied to the embodiments of the present disclosure, which is not described by way of example herein.

At Step S12: The first focal length corresponding to the first distance is acquired according to the first distance.

In a specific embodiment of the present disclosure, a first scale factor corresponding to the first distance is acquired in the preset relation table stored in the terminal, and the preset relation table includes a distance value stored according to the corresponding relationship, the scale range where the distance value is located and the scale factor; and a first focal length corresponding to the first distance is determined according to the first scale factor.

At Step S13: The focal length of the camera is automatically adjusted to be the first focal length.

In a specific embodiment of the present disclosure, when the first distance is changed, it is judged whether the scale factor is changed according to the scale range in the preset relation table stored in the terminal. The focal length of the camera is readjusted according to the current scale factor when the scale factor is changed.

The method for adjusting focal length according to the embodiment of the present disclosure can dynamically adjust the focal length according to the distance between a person and a mobile phone, so that the terminal screen always displays an image of an appropriate ratio, greatly enhancing user experience.

The specific implementation of the embodiment of the present disclosure is illustrated below by way of example.

### Embodiment One

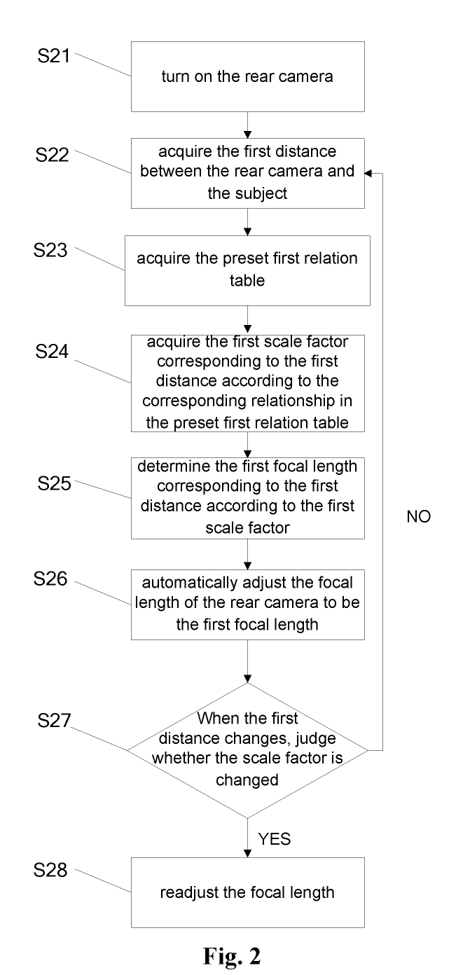

In the method for adjusting focal length provided by the embodiment of the present disclosure, as shown in FIG. 2, it is assumed that the user is to take a selfie, and the method includes the steps.

At Step S21: The user turns on a rear camera.

At Step S22: The first distance between the subject being captured by the rear camera and the rear camera is acquired by an infrared sensor, a Hall component, or an ultrasonic sensor in the terminal. At this time, it is assumed that the distance between the user and the rear camera is 0.5 m.

At Step S23: The preset first relation table stored in the terminal is acquired, as shown in Table 1, and the preset first relation table includes a distance value and a scale factor stored according to a corresponding relationship.

At Step S24: The first scale factor corresponding to the first distance is acquired according to the corresponding relationship in the preset first relation table according to the first distance. It can be seen from the table that when the first distance is 0.5 m, the corresponding first scale factor is K1.

At Step S25: The first focal length corresponding to the first distance is determined according to the first scale factor K1. Specifically, the first focal length corresponding to the first distance is determined by the formula X=K*D, where K presents a scale factor, D presents a focal length of the rear camera, and X presents a first focal length.

At Step S26: The focal length of the rear camera is automatically adjusted to be the first focal length.

TABLE 1

| | Distance value | | | | | | |
|---|---|---|---|---|---|---|---|
| | 0.5 | 1 | 2 | 3 | 4 | 5 | . . . |
| Scale range | [0, 0.5] | [0.5, 1] | [1, 2] | [2, 3] | [3, 4] | [4, 5] | . . . |
| Scale factor | K1 | K2 | K3 | K4 | K5 | K6 | . . . |

In a specific embodiment of the present disclosure, the method further includes the following steps.

At Step S27: When the first distance between the user and the rear camera changes, the width of the face recognition frame in the terminal screen at this time is compared with the width of the screen to acquire a second relative size, and it is judged whether the scale factor is changed according to the scale range, and the preset second relation table includes the relative size and the scale factor stored according to the corresponding relationship.

At Step S28: The focal length of the rear camera is readjusted according to the current scale factor when the scale factor is changed.

### Embodiment Two

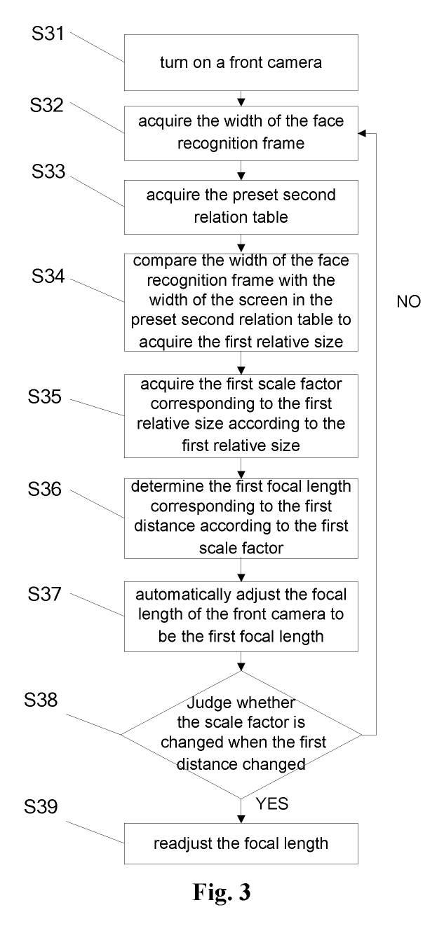

In the method for adjusting focal length provided by the embodiment of the present disclosure, as shown in FIG. 3, it is assumed that the user is to make a video call. The method includes the following steps.

At Step S31: The user turns on a front camera, and the subject being captured is a human face.

At Step S32: The face recognition module of the terminal acquires the size of the face recognition frame on the terminal screen, and the size of the face recognition frame may be specifically the values of the length, width, diagonal, or area of the face recognition frame, and it is assumed that the size of the face recognition frame is the width W of the face recognition frame.

At Step S33: The preset second relation table stored in the terminal is acquired, as shown in Table 2, and the preset second relation table includes the size of the terminal screen, that is, the values of the length, width, diagonal, or area of the terminal screen.

At Step S34: The length, width, diagonal or area of the face recognition frame is compared with the length, width, diagonal or area of the terminal screen correspondingly to acquire the first relative size. At this time, it is assumed that the width of the screen is ¾W, and the first relative size ¾ is acquired after being compared with the width of the face recognition frame for identifying a first distance between the human face and the front camera.

At Step S35: The first scale factor K2 corresponding to the first relative size is acquired according to the corresponding relationship in the preset second relation table according to the above first relative size ¾. Step

At Step S36: The first focal length corresponding to the first distance is determined according to the first scale factor K2 by the formula X=K*D, where K presents a scale factor, D presents a focal length of the front camera, and X presents a first focal length.

At Step S37: The focal length of the front camera is automatically adjusted to be the first focal length.

TABLE 2

| | | | | | | |
|---|---|---|---|---|---|---|
| Width of the screen | W | W | W | W | W | . . . |
| Width of the face | W | ¾W | ½W | ¼W | ⅕W | . . . |
| recognition frame | | | | | | |
| Relative size | 1 | ¾ | ½ | ¼ | ⅕ | . . . |
| Scale range | [¾, 1] | [½, ¾] | [¼, ½] | [⅕, ¼] | [⅛, ⅕] | . . . |
| Scale factor | K1 | K2 | K3 | K4 | K5 | . . . |

In a specific embodiment of the present disclosure, the method further includes the following steps.

At Step S38: When the first distance is changed, it is judged whether the scale factor is changed according to the scale range.

At Step S39: The focal length of the front camera is readjusted according to the current scale factor when the scale factor is changed.

In the process of a video call, the user should get close to the terminal when the user talks. At this time, the first distance is changed, and the second distance between the user and the camera at this time is acquired, and it is judged whether the scale factor changes according to the scale range. When the scale factor is changed, the focal length of the front camera is automatically adjusted to be the second focal length corresponding to the second distance. Similarly, when the user talks away from the terminal, it is judged whether the scale factor is changed according to the third distance between the user and the front camera at this time, and when the scale factor is changed, the focal length of the rear camera is automatically adjusted to be the third focal length corresponding to the third distance.

Of course, the above is merely an example, and in the specific embodiment of the present disclosure, the length, diagonal or area of the face recognition frame may be acquired and the length, diagonal or area of the face recognition frame may be compared with the length, diagonal or area is of the screen to acquire the first relative size.

The method for adjusting focal length according to the embodiment of the present disclosure can automatically adjust the focal length according to the distance between the user and the camera when the user takes a selfie or makes a video call, bringing a great convenience for the user.

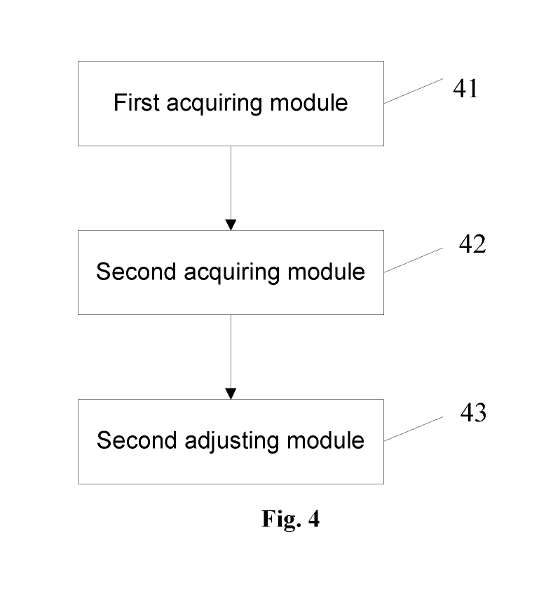

The embodiment of the present disclosure also provides a device for adjusting focal length, which is applied to a terminal. As shown in FIG. 4, the terminal includes:

a first acquiring module 41 configured to, after a camera of a terminal is detected to have been started, acquire a first distance between the subject being captured by the camera and the camera;

a second acquiring module 42 configured to acquire a first focal length corresponding to the first distance according to the first distance; and

a first adjusting module 43 configured to automatically adjust the focal length of the camera to be the first focal length.

In the device provided by the embodiment of the present disclosure, the first acquiring module 41 includes a first acquiring unit configured to acquire a first distance between the subject being captured by the camera and the camera by an infrared sensor, a Hall component, or an ultrasonic sensor in the terminal.

In the device provided by the embodiments of the present disclosure, the second acquiring module 42 includes:

a second acquiring unit configured to acquire a preset first relation table stored in the terminal, and the preset first relation table includes a distance value and a scale factor stored according to a corresponding relationship;

a third acquiring unit configured to acquire a first scale factor corresponding to the first distance according to the corresponding relationship in the preset first relation table according to the first distance; and

a first determining unit configured to determine a first focal length corresponding to the first distance according to the first scale factor.

In the device provided by the embodiments of the present disclosure, the determining unit specifically determines a first focal length corresponding to the first distance by the formula X=K*D, where K presents a scale factor, D presents a focal length of the front camera, and X presents a first focal length.

In the device provided by the embodiments of the present disclosure, the subject captured by the camera is a human face; and the first acquiring module 41 includes:

a fourth acquiring unit configured to acquire the size of the face recognition frame on the terminal screen by a face recognition module of the terminal;

a fifth acquiring unit configured to acquire a preset second relation table stored in the terminal, and the preset second relation table includes: the size of the terminal screen; and

a comparing module configured to compare the size of the face recognition frame with the size of the terminal screen to acquire a first relative size for identifying a first distance between the human face and the camera.

In the device provided by the embodiments of the present disclosure, the preset second relation table further includes a relative size and a scale factor stored according to the corresponding relationship.

In the device provided by the embodiments of the present disclosure, the step of acquiring a first focal length corresponding to the first distance according to the first distance includes:

a sixth acquiring unit configured to acquire a first scale factor corresponding to the first relative size according to the corresponding relationship in the preset second relation table according to the first relative size; and

a second determining unit configured to determine a first focal length corresponding to the first relative size according to the first scale factor.

The device provided by the embodiments of the present disclosure further includes: a judging module configured to, after automatically adjusting the focal length of the camera to be the first focal length, and when the first distance is changed, judge whether the scale factor is changed according to the scale range in the preset relation table stored in the terminal, and the preset relation table includes a distance value stored according to the corresponding relationship, the scale range where the distance value is located and the scale factor; and a second adjusting module configured to readjust the focal length of the camera according to the current scale factor when the scale factor is changed.

The embodiments of the present disclosure also provide a terminal, including the device for adjusting focal length as described above.

It is to be noted that the terminal and the device are terminals and devices corresponding to the above method embodiments, and that all the implementations of the above method embodiments are applicable to the embodiments of the terminal and the device, and the same technical effect can be achieved.

In the embodiments of the present disclosure, the focal length can be dynamically adjusted according to the distance between a person and a mobile phone, so that the terminal screen can always displays an image in an appropriate ratio, thus the user experience is increased greatly.

The foregoing is intended only as a preferred embodiment of the present disclosure and is not intended to be limiting of the present disclosure, and any modifications, equivalent substitutions, improvements, and the like are intended to be included within the scope of protection of the present disclosure.

### INDUSTRIAL APPLICABILITY

As described above, a method, device, and terminal for adjusting focal length provided by the embodiment of the present disclosure has the following advantageous effects: after a camera of a terminal is detected to have been started, acquiring a first distance between the subject being captured by the camera and the camera, and acquiring a first focal length corresponding to the first distance according to the first distance, so as to automatically adjust the focal length of the camera to be the first focal length. In the embodiments of the present disclosure, the focal length can be dynamically adjusted according to the distance between a person and a mobile phone, so that the terminal screen always displays an image in an appropriate ratio, thereby greatly enhancing the user experience.

What is claimed is:

1. A method for adjusting focal length, applied to a terminal, comprising:
after detecting a start of a camera of the terminal, acquiring a first distance between the subject being captured by the camera and the camera;
acquiring a first focal length corresponding to the first distance according to the first distance; and
automatically adjusting the focal length of the camera to be the first focal length.

2. The method as claimed in claim 1, the step of terminal, acquiring the first distance between the subject and the camera after detecting the start of the camera comprises:
acquiring a first distance between the subject being captured by the camera and the camera by an infrared sensor, a Hall component, or an ultrasonic sensor in the terminal.

3. The method as claimed in claim 2, wherein the step of acquiring the first focal length corresponding to the first distance according to the first distance comprises:
acquiring a preset first relation table stored in the terminal, wherein the preset first relation table comprises a distance value and a scale factor stored according to a corresponding relationship;
acquiring a first scale factor corresponding to the first distance according to the corresponding relationship in the preset first relation table; and
determining the first focal length corresponding to the first distance according to the first scale factor.

4. The method as claimed in claim 3, wherein the step of determining the first focal length corresponding to the first distance according to the first scale factor comprises:
determining the first focal length corresponding to the first distance by a formula X=K*D, where K presents a scale factor, D presents a focal length of the camera, and X presents a first focal length.

5. The method as claimed in claim 1, wherein the subject is a human face; and
the step of acquiring the distance between the subject and the camera after detecting the start of the camera comprises:
acquiring, by a face recognition module of the terminal, the size of a face recognition frame on the terminal screen;
acquiring a preset second relation table stored in the terminal, wherein the preset second relation table comprises the size of the terminal screen; and
comparing the size of the face recognition frame with the size of the terminal screen to acquire a first relative size for identifying a first distance between the human face and the camera.

6. The method as claimed in claim 5, wherein the preset second relation table further comprises a relative size and a scale factor stored according to a corresponding relationship.

7. The method as claimed in claim 6, the step of acquiring a first focal length corresponding to the first distance according to the first distance comprises:
acquiring a first scale factor corresponding to the first relative size according to the corresponding relationship in the preset second relation table; and
determining a first focal length corresponding to the first relative size according to the first scale factor.

8. The method as claimed in claim 1, after the step of automatically adjusting the focal length of the camera to be the first focal length, the method further comprises:
when the first distance is changed, judging whether the scale factor is changed according to a scale range in a preset relation table stored in the terminal, wherein the preset relation table comprises the following parameters stored in a corresponding relationship: the distance value, the scale range where the distance value is located, and the scale factor; and
readjusting the focal length of the camera according to the current scale factor when the scale factor is changed.

9. A device for adjusting focal length, arranged in a terminal, comprising:
a first acquiring module configured to, after a start of a camera of a terminal is detected, acquire a first distance between the subject being captured by the camera and the camera;
a second acquiring module configured to acquire a first focal length corresponding to the first distance according to the first distance; and
a first adjusting module configured to automatically adjust the focal length of the camera to be the first focal length.

10. The device as claimed in claim 9, wherein the first acquiring module comprises:
a first acquiring unit configured to acquire a first distance between the subject being captured by the camera and the camera by an infrared sensor, a Hall component, or an ultrasonic sensor in the terminal.

11. The device as claimed in claim 10, wherein the second acquiring module comprises:
a second acquiring unit configured to acquire a preset first relation table stored in the terminal, wherein the preset first relation table comprises a distance value and a scale factor stored according to a corresponding relationship;
a third acquiring unit configured to acquire a first scale factor corresponding to the first distance according to the corresponding relationship in the preset first relation table; and
a first determining unit configured to determine a first focal length corresponding to the first distance according to the first scale factor.

12. The device as claimed in claim 9, wherein the subject is a human face; and
the first acquiring module comprises:
a fourth acquiring unit configured to acquire the size of a face recognition frame on the terminal screen by a face recognition module of the terminal;
a fifth acquiring unit configured to acquire a preset second relation table stored in the terminal, wherein the preset second relation table comprises: the size of the terminal screen; and
a comparing module configured to compare the size of the face recognition frame with the size of the terminal screen to acquire a first relative size for identifying a first distance between the human face and the camera.

13. The device as claimed in claim 12, wherein the second acquiring module comprises:
a sixth acquiring unit configured to acquire a first scale factor corresponding to the first relative size according to the corresponding relationship in the preset second relation table; and
a second determining unit configured to determine a first focal length corresponding to the first relative size according to the first scale factor.

14. The device as claimed in claim 9, wherein the device further comprises:
a judging module configured to, after automatically adjusting the focal length of the camera to be the first focal length, and when the first distance is changed, judge whether the scale factor is changed according to the scale range in the preset relation table stored in the terminal, wherein the preset relation table comprises the following parameters stored in a corresponding relationship: the distance value, the scale range where the distance value is located and the scale factor; and
a second adjusting module configured to readjust the focal length of the camera according to the current scale factor when the scale factor is changed.

15. A terminal, comprising the device for adjusting focal length as claimed in any one of claims 9 to 14.
